(19) United States
(12) Patent Application Publication
(10) Pub. No.: US 2005/0181143 A1
(43) Pub. Date: Aug. 18, 2005

(54) Control method of arranging carbon nanotubes selectively orientationally on the surface of a substrate

(76) Inventors: Yafei Zhang, Shanghai (CN); Yinzhong Guo, Shanghai (CN); Dong Xu, Shanghai (CN)

Correspondence Address: RABIN & Berdo, PC, 1101 14TH STREET, NW, SUITE 500, WASHINGTON, DC, 20005, US

(21) Appl. No.: 10/509,881

(22) PCT Filed: Mar. 17, 2003
(86) PCT No.: PCT/CN03/00195

(30) Foreign Application Priority Data
Apr. 12, 2002 (CN) 02111337.8

(51) Int. Cl. B05D 3/00

(52) U.S. Cl. 427/532; 427/299

(57) ABSTRACT

The control method of arranging carbon nanotubes selectively orientationally on the surface of a substrate relates to the field of nano-technology. The invention includes: a) treating the solid substrate to be hydrophilic or hydrophobic; b) attaching the organic macromolecular with hydrophilic and hydrophobic end to the surface of the purified carbon nanotubes, and dissolving those carbon nanotubes into water or a solvent; c) spreading the above solution onto the surface of water in sub-phase by controlling the surface pressure-area isotherm of the carbon nanotube film on the water surface after volatilization of water or the organic solvent; d) transferring the formed carbon nanotube film to the above treated solid substrate surface to form the arrangement layer of the carbon nanotubes. This invention possesses substantial characteristics and notable improvement. The present invention can control the arrangement direction of the carbon nanotubes and can successively remove organic molecule.

### FIELD OF THE INVENTION

The invention relates to a method of arranging carbon nanotubes, and particularly to a control method of arranging carbon nanotubes selectively orientationally on the surface of a substrate, which relates to the field of nano-technology.

### BACKGROUND OF THE INVENTION

Since the first discovery and report of carbon nanotubes of single-wall and multi-wall in 1991, for its particular length-diameter ratio, mechanics of super-toughness, and other's excellent thermics, optics and electronics, they have been suggested for many potential application in field of electron emission, polar of lithium cell, probe of scan probe microscopy and semic-conduting electronics. But one reason that application study of carbon nanotubes has not made breakthrough progress is their insolubility in solvents, which makes it difficult to obtain monolayer carbon nanotubes arraying with equably dispersion and large area arrangement in order. Sprayed SWCNT thin films are used to measure carbon nanotubes' optical absorption spectra, in order to establish the relationship between the density of states distribution and the diameter of carbon nanotubes, and to elucidate the mechanisms by which chemical and electrochemical doping or high pressure used modify the carbon nanotubes' electronic states. For such sprayed films, however, the inhomogeneous aggregation of carbon nanotubes inevitably bring about a rough surface, due to lack of control of the thickness and orientation of the deposited carbon nanotubes. The development of rational processing techniques for carbon nanotubes is crucial for their technological applications and further understanding of their fundamental properties. Particularly, the realization of uniform thin films with controlled film thickness and nanotube orientation is important for the application of a number of new optical and electric characterization techniques. The Langmuir-Blodgett (LB) technique is a common method for preparation of the molecular film, which is to disperse bi-lipophilic molecular insoluble in water into purified-water in sub-phase to form a super-thin monolayer in liquid surface after organic solvent is volatilize out, then to concentrate and transfer by control, and to test film-pressure of molecular on liquid surface by precise electronic-microbalance, finally to form LB film. For carbon nanotubes are insoluble in any solvents, it is impossible to form LB films directly from them. Kristic et al. reported in Synthetic Metals of Vol. 100 page 245-249 in 2000 that carbon nanotubes monolayer could be prepared by dispersing carbon nanotubes in a surfactant lithium dodecyl sulfate on a sub-phase of aqueous solution. The monolayer molecular could be horizontally deposited onto solid substrates. However, due to their limited solubility in aqueous solution, the concentration of carbon nanotubes in the deposited monolayer is quite low (<7%), so that neither deposition nor the control of the tube orientation is achieved by this method.

### PURPOSE OF THE INVENTION

The object of this invention is to overcome the disadvantages of the existing techniques, and to provide a control method of arranging carbon selectively orientationally on the surface of a substrate. LB technique is used to achieve the monolayer and multiplayer orientational film of carbon nanotubes on the surface of all kinds of substrates. UV-visible-IR absorption spectra, quartz crystal micro-balance (QCM), AFM and polarized Raman spectra are used to investigate the quality of the carbon nanotube molecular film and direction of carbon nanotubes.

### SUMMARY OF THE INVENTION

Detailed method of this invention is as follows:

Solid substrate is treated to be hydrophilic or hydrophobic.

Organic macromolecular with a hydrophilic and hydrophobic end is combined to the surface of every carbon nanotubes which has been purified routinely, and then the resulted carbon nanotubes is dissolved into water or organic solvent.

The said solution is spread onto the surface of water in sub-phase, then after the water or the organic solvent has been volatile out, the surface pressure-area isotherm of the carbon nanotube thin film with single molecular on the water surface is controlled to press film.

The resulted carbon nanotube film with single layer is transferred to the surface of the said solid substrate to form the arrangement layer of carbon nanotubes.

Hydrophilic treatment of the said solid substrate is to submerge the substrate into concentrate acid above 50° C., and hydrophobic treatment of that is to silanize the substrates after hydrophilic treatment.

The concentrate acid can be the concentrated nitric acid.

The said carbon nanotubes combined with organic macromolecular with a hydrophilic and hydrophobic end is embodied as that carbon nanotubes will be sulfated/nitridized firstly to form carboxyl group at each end and side of the tube, and then acylated and aminated to attach the organic macromolecular.

Wherein, surface pressure-area isotherm of the carbon nanotube single-molecular thin film is controlled during step 3) with pressure about 20-50 mN/m.

In addition, light irradiation of high energy is applied to carbon nanotube monolayer film formed in step 4), in order that some organic macromolecular with hydrophilic and hydrophobic end are decomposed and evaporated from the substrate.

Here the high energy light can be UV irradiation.

Of course, hundreds of layers can be obtained by controlling pressure of film and repeating the above procedures.

Uniform multiplayer films of carbon nanotube with controllable thickness have been prepared by the LB technique. In the films, chemically modified carbon nanotubes are oriented almost along the one orientation (selected orientation), thus, carbon nanotubes molecular film of controlled thickness and orientation control of tubes may help pave the way to the development of molecular devices using carbon nanotubes. What's more, those devices can be used to characterize the electrical and optical properties of carbon nanotubes, such as testing the electrical conductivity of nanomaterials and producing the nano raster.

This invention possesses substantial characteristics and notable improvement. The array direction of carbon nanotubes can be controlled artificially, that is to say, the array direction of carbon nanotubes in carbon nanotubes thin film can be controlled by outer pressure during the preparation. Then the obtained carbon nanotube thin film can be successfully transferred onto either the hydrophobic and the hydrophilic surface of solid substrates. Organic in chain which is introduced during preparation can be removed successfully by decomposing and evaporating from the substrate after light irradiation of high energy, while carbon nanotubes film itself can not be disrupted on the substrate because of its high stability.

### BRIEF DESCRIPTION OF THE DRAWINGS

FIG. 1 shows surface pressure-area isotherm (π-A isotherm) of water in sub-phase after carbon nanotubes of the invention dispersed on the water surface of chloroform sultion.

FIG. 2 shows UV-visible-IR absorption spectra of carbon nanotubes LB films.

### DESCRIPTION OF THE INVENTION

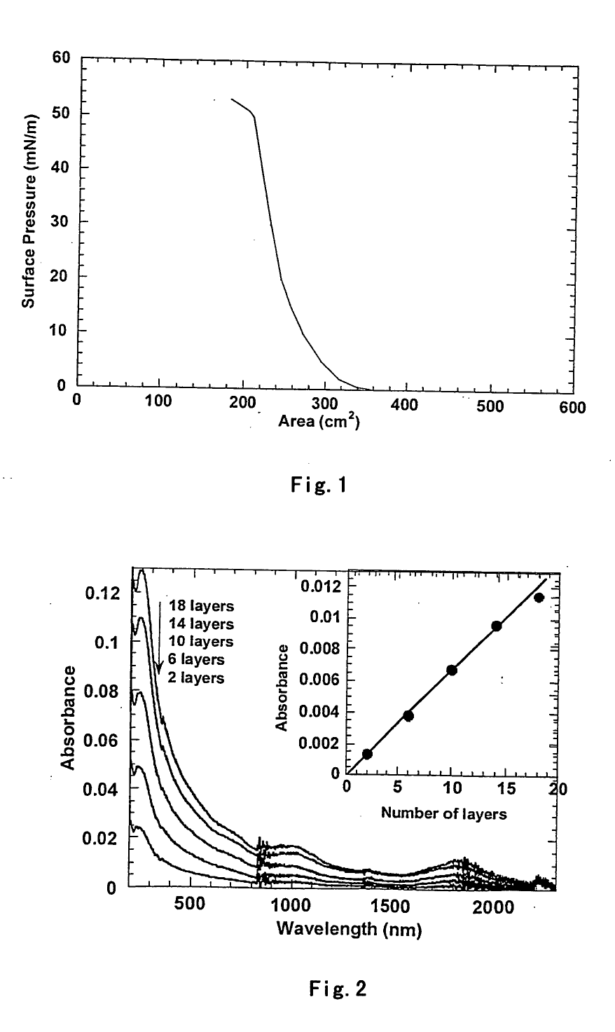

As shown in FIG. 1 and 2, the invention combined with figures will be described further as follows. A solid substrate is submerged into 50° C. concentrated nitric acid or further is treated by silanization. The carbon nanotubes are purified and cut off by normal concentrated acid, heating, ultrasonic, and filtration et al. Long carbon nanotubes will be cut short firstly at the point of defects, then sulfated (nitridized) to form carboxylic groups at both ends and sides of the carbon nanotubes, thirdly acyl-chlorinated and acyl-aminated to attach organic macromoleculars, finally dissolved into chloroform solvent.

After above steps, 400 μl chloroform solution with a concentration of 0.1-0.5 mg/ml of carbon nanotubes is spread uniformly on water surface in sub-phase to measure π-A isotherms after chloroform is volatile out. As shown in figure, there is steep rise in surface pressure and high negative pressures (20-50 mN/m ), and the shape of the isotherm doesn't significantly depend on temperature. The surface film in sub-phase is compressed continuously at a speed of 20-50 mN/m. in order that the carbon nanotube molecules get closer and closer and adjust their attitudes one another. The pressure keeps unchanged until those molecules lay compactly. After the vibration and the orientation of carbon nanotubes are completed, the molecular film is in orientation and order. The carbon nanotubes film on the surface of the liquid are lift and successfully transferred onto the surface of the above solid substrates, with a transfer ratio of 0.97-0.99. The above compressing and lifting are completed by an LB equipment which equips with a computer's controlling system and a Wilhelmy balance. The surface area of carbon nanotubes monolayer on the water surface depends on negative pressure. Extrapolation of the steeply rising portion of the π-A isotherms to zero pressure gives the occupied surface area of the condensed monolayer on the water surface. The density of carbon nanotubes is approximately 2.0×10⁻⁴ mg/cm⁻². Judged from the radial breathing model of the Raman spectrum at 170 cm-1, the average diameter of solubilized carbon nanotube is about 1.32 nm, which geometrically corresponds to 158 carbon atoms per 1 nm length along the tube axis. Surface density of close packed carbon nanotube monolayer is 2.39×10⁻⁴ mg/cm², while experimental value is about 2.0×10⁻⁴ mg/cm² because the formation of carbon nanotubes monolayer on water surface attribute to chains molecular adhering to on it that has a hydrophilic and hydrophobic end. About 16.3% smaller than the calculated value suggests that carbon nanotubes distribute loosely in monolayer.

The transfer ratio of carbon nanotubes formed by above step is 0.8. As shown in FIG. 2, the UV-visible-IR absorption spectra of carbon nanotubes LB films, each spectrum displays three major absorption peaks at 1820, 1000 and 700 nm respectively. The first two of the three come from the first and the second inter band optical transitions in semi-conducting carbon nanotubes and the last from optical transitions in metallic carbon nanotubes. The peak absorbance at 1820 nm plotted against the number of layers gives a perfectly straight line up to 14 layers. This demonstrates that the layer-by-layer deposition of homogeneous, multiplayer LB films with precisely controlled thickness is successfully achieved. At a surface pressure of 20-50 mN/m, the carbon nanotubes monolayer is deposited on the end face of the quartz crystal micro-balance tip (tip area=0.196 cm²) to form LB film. The mass of carbon nanotube film on the tip increases with the number of layers, which also give a close linear relationship. This result further suggests that a carbon nanotube form a fairly uniform LB film. After 14 layers have been deposited, the mass of carbon nanotube LB film on the tip is 8.23×10⁷ g, which is consistent with the value of 1.1×10⁶ g calculated from the limiting surface area of 2.0×10⁴ mg/cm².

When the prepared carbon nanotube LB monolayer film is observed using AFM, no clear images are obtained due to the effect of long chains with a hydrophilic and hydrophobic end, which reduce the resolution of AFM tip. After further treatment for this, for example UV irradiation for a short time, some chains are decomposed and evaporated from the substrate, while carbon nanotubes remain on the substrate because of its high stability.

The orientation of carbon nanotubes in LB film is further investigated by means of polarized Raman spectroscopy. Raman peaks at 170 and 1590 cm⁻¹ attributes to the radial breathing mode and tangential stretching G-bond modes, respectively. The peak intensities vary with the measure angle between the polarization direction and the nanotube axis. Particularly, the experimental intensities of G-bond modes exhibit a characteristic minimum near 60⁰ in excellent agreement with the theory value of carbon nanotubes. (Theoretically, the intensity of the tangential mode is expected to exhibit a minimum at θ=54.7⁰.)

This invention is not limited in above example. Other organic volatile solvents the carbon nanotubes can also be dissolved into, can be chloroform and dichloromethane et al. The carbon nanotubes can be attached with amine molecules and dissolved in water or ethanol solvents.

1. The control method of arranging carbon nanotubes selectively orientationally on the surface of a substrate comprising:
1) solid substrate is treated to be hydrophilic or hydrophobic;
2) organic macromolecular with a hydrophilic and hydrophobic end is combined to the surface of every carbon nanotubes which has been purified routinely, and then the resulted carbon nanotubes is dissolved into water or organic solvent;
3) the said solution is spread onto the surface of water in sub-phase, then after the water or the organic solvent has been volatile out, the surface pressure-area isotherm of the carbon nanotube thin film with single molecular on the water surface is controlled to press film;
4) the resulted carbon nanotube film with single layer is transferred to the surface of the said solid substrate to form a arrangement layer of carbon nanotubes.

2. The control method of claim 1, wherein hydrophilic treatment of the said solid substrate is to submerge the substrate into concentrate acid above 50° C., and hydrophobic treatment of that is to silanize the substrates after hydrophilic treatment.

3. The control method of claim 2, wherein the concentrate acid is the concentrated nitric acid.

4. The control method of claim 1, wherein carbon nanotubes will be sulfated/nitridized firstly to form carboxyl group at each end and side of the tube, and then acylated and aminated to attach the organic macromolecular.

5. The control method of claim 1, wherein surface pressure-area isotherm of the carbon nanotube single-molecular thin film is controlled during step 3) with pressure about 20-50 mN/m.

6. The control method of claim 1, wherein light irradiation of high energy is applied to carbon nanotube monolayer film formed in step 4), in order that some organic macromolecular with hydrophilic and hydrophobic end are decomposed and evaporated from the substrate.

7. The control method of claim 6, wherein the high energy is UV irradiation.

8. The control method of claim 2, wherein light irradiation of high energy is applied to carbon nanotube monolayer film formed in step 4), in order that some organic macromolecular with hydrophilic and hydrophobic end are decomposed and evaporated from the substrate.

9. The control method of claim 3, wherein light irradiation of high energy is applied to carbon nanotube monolayer film formed in step 4), in order that some organic macromolecular with hydrophilic and hydrophobic end are decomposed and evaporated from the substrate.

10. The control method of claim 4, wherein light irradiation of high energy is applied to carbon nanotube monolayer film formed in step 4), in order that some organic macromolecular with hydrophilic and hydrophobic end are decomposed and evaporated from the substrate.

11. The control method of claim 5, wherein light irradiation of high energy is applied to carbon nanotube monolayer film formed in step 4), in order that some organic macromolecular with hydrophilic and hydrophobic end are decomposed and evaporated from the substrate.

12. The control method of claim 8, wherein the high energy is UV irradiation.

13. The control method of claim 9, wherein the high energy is UV irradiation.

14. The control method of claim 10, wherein the high energy is UV irradiation.

15. The control method of claim 11, wherein the high energy is UV irradiation.
